(19) United States
(12) Patent Application Publication
(10) Pub. No.: US 2006/0224720 A1
(43) Pub. Date: Oct. 5, 2006

(54) Method, computer program product, and system for mapping users to different application versions

(76) Inventors: Kulvir Singh Bhogal, Fort Worth, TX (US); Alexandre Polozoff, Bloomington, IL (US)

Correspondence Address: IBM CORP (YA);C/O YEE & ASSOCIATES PC, P.O. BOX 802333, DALLAS, TX, 75380, US

(21) Appl. No.: 11/077,328

(22) Filed: Mar. 10, 2005

(51) Int. Cl. G06F 15/173

(52) U.S. Cl. 709/224

(57) ABSTRACT

A method, computer program product, and a data processing system for mapping a user to an application in a data processing system network are provided. An application service request from a client is received. The request is directed to a first network address. A user identifier from which the request originated is received. Responsive to receiving the user identifier, a first application version to which the user identifier is associated is identified. The first application version is one of a plurality of application versions. Responsive to identifying the first application version, the request is processed with a second network address that is associated with the first application version.

### BACKGROUND OF THE INVENTION

1. Technical Field

The present invention relates generally to an improved data processing system and in particular to a data processing system and method for mapping a user to an application version. Still more particularly, the present invention provides a mechanism for mapping users accessing applications at a common network address to different application versions.

2. Description of Related Art

Many enterprise environments have a number of packaged applications of different versions of common applications. For example, many national business enterprises, such as insurance companies, with Web presences deploy different versions of applications to accommodate differences in state laws. In such instances, users at different geographic locales have to access different URLs even though they are essentially using the same application but with slight variations dependent on where the user is located.

Conventional solutions for accommodating access of different users to different application versions have included mapping users to different application versions. This mechanism requires user mappings to be deployed in code that has to be maintained and often redeployed. Additionally, mappings deployed in code do not allow for declarative mapping through the application server's administrative interface. Moreover, code-level user mappings are complex to administer at a cluster level.

Thus, it would be advantageous to provide a mechanism for deploying different versions of applications in a network for access by clients. It would be further advantageous to provide a mechanism for deploying different versions of applications in a network in a manner that allows access of the different application versions by clients via a common network address.

### SUMMARY OF THE INVENTION

The present invention provides a method, computer program product, and a data processing system for mapping a user to an application in a data processing system network. An application service request from a client is received. The request is directed to a first network address. A user identifier from which the request originated is received. Responsive to receiving the user identifier, a first application version to which the user identifier is associated is identified. The first application version is one of a plurality of application versions. Responsive to identifying the first application version, the request is processed with a second network address that is associated with the first application version.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a client data processing system in which the present invention may be implemented;

FIG. 4 is a diagrammatic illustration of a network system in which different users are mapped to different versions of an application in accordance with a preferred embodiment of the present invention;

FIG. 5 is a diagrammatic illustration of an application version map used for mapping users to application versions in accordance with a preferred embodiment of the present invention; and

FIG. 6 is a flowchart of an application server routine processing for mapping users to application versions in accordance with a preferred embodiment of the present invention.

### DETAILED DESCRIPTION OF THE PREFERRED EMBODIMENT

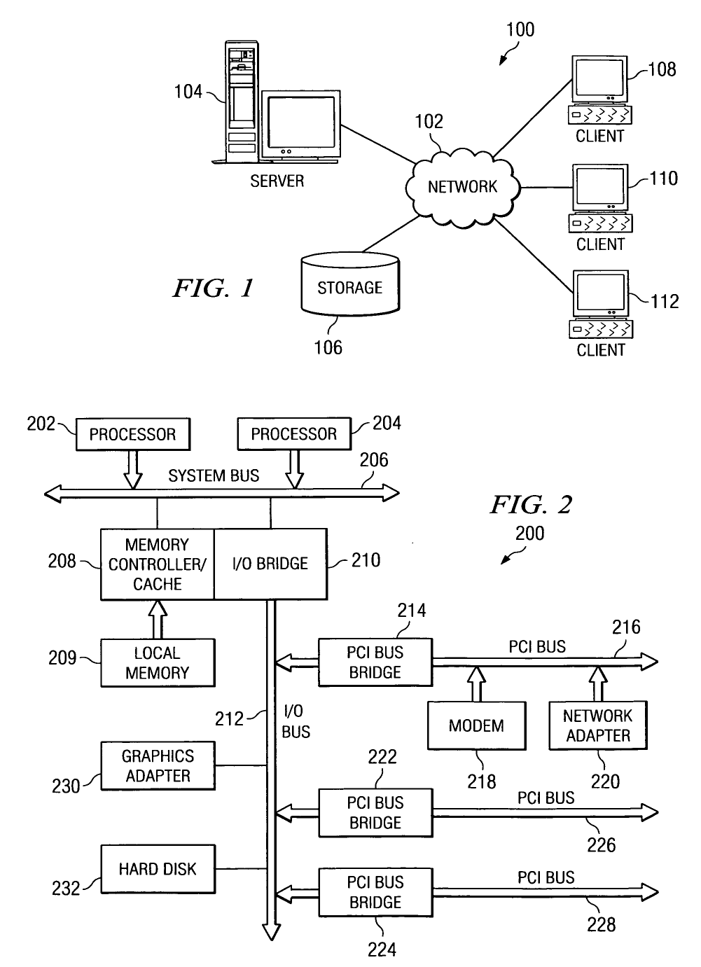

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

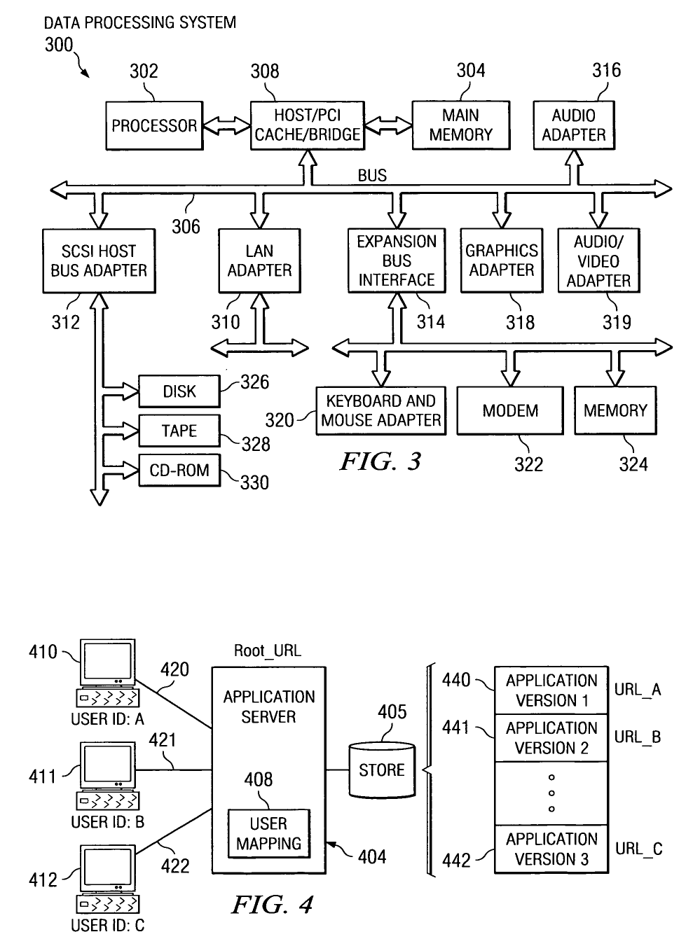

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a diagrammatic illustration of a network system in which different users are mapped to different versions of an application in accordance with a preferred embodiment of the present invention. In the illustrative example, an application server 404 sends web pages or other application data to clients 410-412 by way of respective client connections 420-422 responsive to receiving HTTP requests therefrom. Additionally, application server 404 may provide data other than HTTP data, such as applications, to clients 410-412. Application server 404 interfaces and communicates with storage device 405 that maintains different versions of an application. In the illustrative example, storage device 405 includes an application group comprising three different application versions 440-442 (illustratively designated Application Version 1-Application Version 3). Application server 404 handles application operations between browser-issued requests issued by clients 410-412 and back-end applications, such as applications maintained by storage device 405. Other devices may be deployed in network 400 for implementing application services to clients 410-412. For example, clients 410-412 may connect with a web server that is deployed between clients 410-412 and application server 404 that facilitates connectivity of clients 410-412. In the illustrative example shown, application server 404 provides connectivity services to clients 410-412.

In accordance with a preferred embodiment, application server 404 prompts clients 410-412 for authentication data, such as a user identification (User ID). In the illustrative example, an administrator or other entity respectively assigns clients 410-412 user IDs of A-C. Thus, a client wishing to be provided with application services from application server 404 logs onto application server 404, e.g., by entry of a uniform resource locator (URL) of web application server 404 in a suitable web browser, and provides an identification assigned to the user of the client responsive to receiving a prompt for the user ID from applications server 404. In the illustrative example, application server is located at an address of Root_URL, and thus the application group comprising application versions 440-442 is associated with the application server network address Root_URL.

In the illustrative example, application server 404 maintains an application version map 408 implemented as a set of instructions that a processing unit of application server 404 fetches from memory for execution. Application version map 408 logically maps, or associates, users (or user groups) to one of application versions 440-442 so that users can be directed to the version of the application based on the mapping. Thus, users may connect with an application server through a common address, e.g., a common URL, and be provided with different versions of a common application. While the application version map is shown deployed at application server 404, other implementations are possible and the particular configuration shown is illustrative only. For example, a router or other network device with suitable processing capabilities may deploy the application version map.

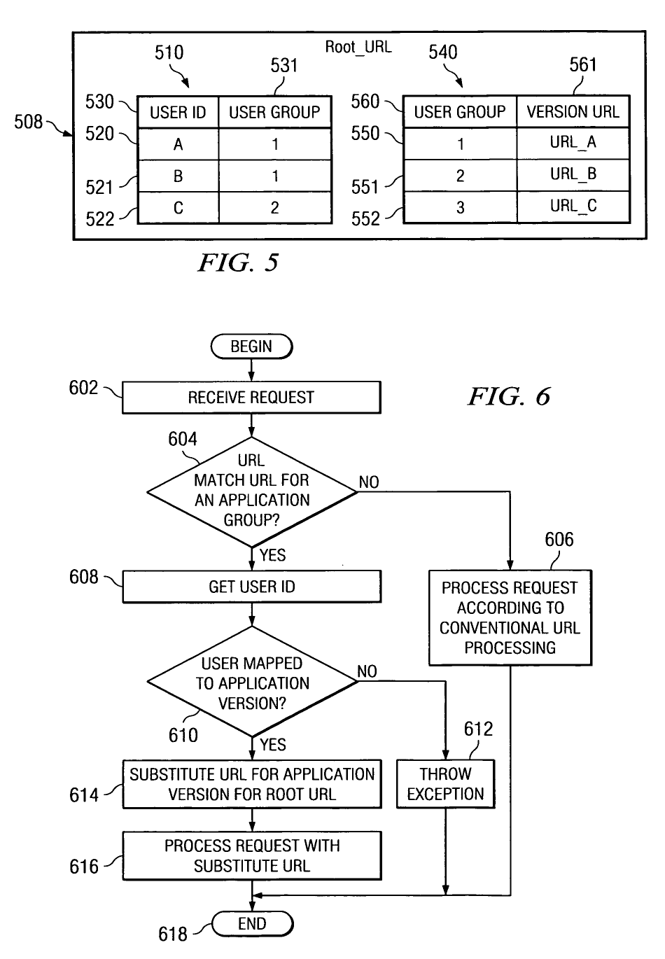

FIG. 5 is a diagrammatic illustration of an application version map used for mapping users to application versions in accordance with a preferred embodiment of the present invention. Application version map 508 is an example of an application version map, such as application version map 408, run by a server, such as application server 404, that provides application services to clients. Application version map 508 is preferably assigned a URL to which users that access different application versions may commonly access one of the plurality of different application versions. In the illustrative example, application version map 508 provides logical mappings of users accessing an application at a URL of “Root_URL” to different application versions.

Application version map 508 comprises tables 510 and 540. Table 510 associates user IDs with one of a plurality of user groups, and table 540 associates user groups with application version addresses, e.g., application version URLs. In particular, table 510 includes records 520-522 that each define associations between users and user groups. In the illustrative example, each record of table 510 includes a user identification in user ID field 530 and a user group in user group field 531 to which the user of the corresponding record is assigned. For example, record 520 of table 510 specifies that a user having a user ID of “A” is assigned to a user group “1”. In a similar manner, records 521 and 522 respectively specify that users having user IDs of “B” and “C” are assigned to user groups of “1” and “2”.

Table 540 defines associations between user groups and application version addresses, e.g., URLs at which different versions of an application are located. In the illustrative example, each record of table 540 includes a user group identification in user group field 560 and an application version location identifier in version URL field 561. For example, record 550 of table 540 specifies that users of user group “1” are associated with an application version located at a location of URL_A. In a similar manner, records 551 and 552 respectively specify that users of user groups “2” and “3” are assigned to application versions located at locations of URL_B and URL_C.

Responsive to receipt of a user ID, the application server identifies a user group to which the user ID is associated. In turn, the application server then identifies a location at which an application version associated with the user group is located. Although the illustrative example described utilizes user groups mappings to application versions, such an implementation is exemplary only. For example, users may be directly mapped to an application version without assignment of users to user groups.

FIG. 6 is a flowchart of an application server routine processing for mapping users to application versions in accordance with a preferred embodiment of the present invention. The application server routine is preferably implemented as a set of instructions fetched from memory and executed by a processing unit of the application server.

The application server routine begins and receives a request (step 602), for example a client request for an application service. The application server then evaluates the URL at which the request was directed to determine if the URL matches or is otherwise associated with a URL assigned to an application group (step 604). If the URL does not match a URL of an application group, the application server routine proceeds to process the request according to conventional URL processing (step 606), and the application server routine cycle then ends (step 618).

Returning again to step 604, if the URL at which the received request was directed is identified as matching a URL of an application group, the application server routine then proceeds to get a user ID of the user that issued the request (step 608). For example, the application server may return a prompt for a user ID and await a response from the user. Alternatively, a user role or other user characteristic, e.g., an employment position, to which application version mappings may be defined can be substituted for the user ID.

After the user ID or other user descriptor is received by the application server, the application server routine then evaluates the user ID to determine if a mapping for the user ID is defined (step 610). If no mapping is identified for the user ID, the application server routine throws an exception (step 612), e.g., an error code may be returned to the user, and the application server routine cycle then ends according to step 618.

Returning again to step 610, if a valid mapping for the user ID is identified, the application server routine then substitutes the URL of the application version to which the user ID is mapped for the URL to which the user request was directed (step 614), and processes the request with the substituted URL (step 616). The application server routine cycle then ends according to step 618.

As described, a mechanism for deploying different versions of applications in a network for access by clients is provided by embodiments of the present invention. Different application versions are deployed in a network system and each application version has a unique URL associated therewith. A mechanism maps users to different application versions, for example, via user group and application version URL mappings. On receipt of a user ID, a data processing system identifies an application version URL associated with the user ID, and processes the request processed with the URL of the application version to which the user ID is mapped.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of facilitating access of a user to one of a plurality of application versions in a data processing system network, comprising:
receiving, by a data processing system, an application service request from a client, wherein the request is directed to a first network address;
receiving, by the data processing system, a user identifier from which the request originated, wherein the user identifier identifies a user of the client;
responsive to receiving the user identifier, identifying, by the data processing system, a first application version to which the user identifier is associated, wherein the first application version is one of the plurality of application versions; and
responsive to identifying the first application version, processing, by the data processing system, the request with a second network address that is associated with the first application version.

2. The method of claim 1, wherein the first network address comprises a uniform resource locator that defines a network address to which an application server is deployed in the network, and wherein each of the plurality of application versions are respectively associated with one of a plurality of uniform resource locators.

3. The method of claim 1, further comprising:
responsive to receiving the request, determining, by the data processing system, the first network address is associated with an application group that comprises the plurality of application versions, wherein receiving the user identifier is performed responsive to determining the first network address is associated with the application group.

4. The method of claim 1, wherein identifying the first application version to which the user identifier is associated further comprises:
identifying, by the data processing system, a user group to which the user identifier is assigned; and
determining the user group is associated with the first application version, wherein processing the request is performed responsive to determining the user group is associated with the first application version.

5. The method of claim 4, further comprising:
prompting, by the data processing system, the user for the user identifier responsive to determining the first network address is associated with the plurality of application versions.

6. The method of claim 1, wherein the first network address comprises a root address and the second network address comprises one of a plurality of network addresses associated with the first network address.

7. The method of claim 6, wherein each of the plurality of application versions is respectively associated with one of the plurality of network addresses.

8. A computer program product in a computer readable medium for mapping a user to an application in a data processing system network, the computer program product comprising:
first instructions that receive an application service request from a client, wherein the request is directed to a first network address;
second instructions that identify a user identifier from which the request originated;
third instructions that, responsive to the second instructions identifying the user identifier, identify a first application version to which the user identifier is associated, wherein the first application version is one of a plurality of application versions; and
fourth instructions that, responsive to the third instructions identifying the first application version, process the request with a second network address that is associated with the first application version.

9. The computer program product of claim 8, wherein the first network address comprises a uniform resource locator that defines a network address to which an application server is deployed in the network.

10. The computer program product of claim 8, further comprising:
fifth instructions that, responsive to the first instructions receiving the request, determine the first network address is associated with an application group.

11. The computer program product of claim 10, further comprising:
sixth instructions that, responsive to the first instructions receiving the request, determine the first network address is associated with the application group.

12. The computer program product of claim 8, wherein the third instructions identify the first application version to which the user identifier is associated by identifying a user group to which the user identifier is assigned.

13. The computer program product of claim 12, wherein the user group is associated with the first application version.

14. The computer program product of claim 8, wherein each of the plurality of application versions are respectively associated with one of a plurality of uniform resource locators.

15. A data processing system adapted to map a user to an application, comprising:
a memory that contains a set of instructions that map users to one of a plurality of application versions; and
a processing unit that, responsive to execution of the set of instructions, receives an application service request directed to a first network address, identifies a user identifier from which the request originated, and identifies a first application version to which the user identifier is associated, wherein the first application version is one of the plurality of application versions, and responsive to identifying the first application version, that processes the request with a second network address that is associated with the first application version.

16. The data processing system of claim 15, wherein the first network address comprises a uniform resource locator that defines a network address to which the data processing system is deployed in the network.

17. The data processing system of claim 15, wherein the processing unit, responsive to receiving the request, determines the first network address is associated with an application group.

18. The data processing system of claim 17, wherein the user identifier is identified responsive to determining the first network address is associated with the application group.

19. The data processing system of claim 15, wherein the processing unit identifies the first application version to which the user identifier is associated by identifying a user group to which the user identifier is assigned.

20. The data processing system of claim 19, wherein the user group is associated with the first application version.
